(19) United States
(12) Patent Application Publication
(10) Pub. No.: US 2011/0132498 A1
(43) Pub. Date: Jun. 9, 2011

(54) Composition for Chemical Conversion Treatment and Member Having a Chemical Conversion Film Formed by the Treatment

(75) Inventors: Naruhiko Nojima, Aichi (JP); Shusaku Ishikawa, Aichi (JP); Tomoko Ishikawa, Aichi (JP)

(73) Assignee: YUKEN INDUSTRY CO., LTD., Kariya-shi, Aichi (JP)

(21) Appl. No.: 12/994,348

(22) PCT Filed: Jan. 29, 2010
(86) PCT No.: PCT/JP2010/051247

§ 371 Date: Feb. 14, 2011

(30) Foreign Application Priority Data
Jan. 30, 2009 (JP) 2009-019983

(51) Int. Cl. C23C 22/05; C09K 3/00

(52) U.S. Cl. 148/267; 252/186.1

(57) ABSTRACT

A chemical conversion treatment solution comprising, based on the total composition, 0.1 g/L to 3.0 g/L of an aqueous cobalt-containing substance in cobalt equivalent, 0.05 g/L to 3.0 g/L of a pyrogallol compound in pyrogallol equivalent, and at least 1.5 g/L of an aqueous trivalent chromium-containing substance in chromium equivalent, the composition being acidic and the ratio of the content of the pyrogallol compound in pyrogallol equivalent to the content of the aqueous cobalt-containing substance in cobalt equivalent being 0.015 to 10, wherein a chemical conversion film formed on the metallic surface of a member by contacting the metallic surface with the composition for chemical conversion treatment has a content of hexavalent chromium of 0.050 μg/cm² or less as measured by a method compliant with EN15205 after exposure to an environment having a temperature of 80° C. and a relative humidity of 100% for 72. hours.

### TECHNICAL FIELD

The present invention relates to a composition for chemical conversion treatment which is capable of forming a chemical conversion film from which elution of hexavalent chromium, which is harmful to the environment, is inhibited and a member having a chemical conversion film formed by the chemical conversion treatment. More specifically, the present invention relates to a composition for chemical conversion treatment, a dense composition for preparing the composition, and a method of manufacturing a member having a chemical conversion film formed from the composition.

### BACKGROUND ART

Recently, the use of hazardous metals such as lead, mercury, cadmium, and hexavalent chromium has been restricted by environmental regulations such as RoHS (Restriction of the Use of Certain Hazardous Substances in Electrical and Electronic Equipment) and ELV (End of Life Vehicles) Regulations.

In accordance with this movement, a chromate film, which is effective as an anticorrosive chemical conversion film for a member having a metallic surface such as a galvanized member, has been formed not by a composition for chemical conversion treatment (which may be referred to below as a chemical conversion treatment solution) using a chromate salt containing hexavalent chromium but by a chemical conversion treatment solution containing trivalent chromium. A chemical conversion film obtained from a conventional chemical conversion treatment solution containing hexavalent chromium has hexavalent chromium which is soluble in water. Therefore, use of such a film is restricted by the above-mentioned regulations.

Although a chromate film formed by a chemical conversion treatment solution containing trivalent chromium has become common, it has been found that an extremely small amount of hexavalent chromium is detected in the chemical conversion film formed by the chemical conversion treatment solution. Depending on the method of measurement, the amount of elution from the coating is roughly 0.1 micrograms/cm² or less, which is far smaller than the amount of elution from a chemical conversion film obtained from a conventional chemical conversion treatment solution containing hexavalent chromium.

Nevertheless, methods of decreasing the amount of hexavalent chromium eluted from a chemical conversion film obtained from a conventional chemical conversion treatment solution containing trivalent chromium (which may be referred to below as chemical conversion film) are being investigated.

Patent Document 1 discloses a method of decreasing the amount of elution of hexavalent chromium by immersing a metallic member having a chemical conversion film in a reduction treatment solution having a prescribed content of a reducing agent for a prescribed period as a process for reducing hexavalent chromium, followed by drying the metallic member after immersion. L-ascorbic acid is preferably used as the reducing agent.

Patent Document 2 discloses a method of adding a reducing agent to reduce hexavalent chromium to trivalent chromium in a chemical conversion treatment solution. A preferable reducing agent for this method is sodium bisulfite, which is added before and after adding a supporting salt.

Patent Document 1: JP2005-240084A

Patent Document 2: JP2006-28547A

### DISCLOSURE OF INVENTION

It has not been clarified why hexavalent chromium is eluted from a chemical conversion film obtained from a chemical conversion treatment solution containing trivalent chromium. Therefore, it is not clear whether adding the above-described reducing reagents are the best means for inhibiting elution of hexavalent chromium.

In addition, while the effect of inhibiting elution of hexavalent chromium needs to last for a long period, Patent Document 2 only discloses the amount of elution just after the formation of a chemical conversion film, and Patent Document 1 only discloses the amount of elution after 10 days of storage in a normal environment. Therefore, it is still unclear whether the effects of the above-mentioned means for inhibiting elution of hexavalent chromium can last for a long period.

Regarding this point, the present inventors measured the amount of elution of hexavalent chromium from a chemical conversion film after storage in an environment having a high temperature and high humidity (80 degrees C. and 100% RH). The result showed that hexavalent chromium was eluted rapidly in a short period (about 1 day) from a chemical conversion film obtained from a chemical conversion treatment solution containing a substance which was thought to be effective for reducing the elution of hexavalent chromium from a chemical conversion film. This substance is generically referred to below as an elution inhibitor. In addition, it was found that when a chemical conversion treatment solution contains a conventional elution inhibitor, a chemical conversion film obtained from the chemical conversion treatment solution is colored yellow or brown.

Therefore, the object of the present invention is to provide a novel means for inhibiting elution of hexavalent chromium from a chemical conversion film, and specifically a means for inhibiting elution of hexavalent chromium from a chemical conversion film even after storage in an environment having a high temperature and high humidity and being capable of forming a chemical conversion film having a high degree of corrosion resistance and superior appearance.

The present inventors investigated how to achieve this object and found that the amount of elution of hexavalent chromium from a chemical conversion film is reduced when the content of an aqueous cobalt-containing substance such as a cobalt ion, which is often added to a chemical conversion treatment solution so as to increase the corrosion resistance of a chemical conversion film, is decreased.

The present inventors diligently searched for a component which is capable of inhibiting the elution of hexavalent chromium from a chemical conversion film especially when a chemical conversion treatment solution contains an aqueous cobalt-containing substance which has an effect of improving corrosion resistance and which is capable of having little effect on the change of appearance of the chemical conversion film, since the corrosion resistance of a chemical conversion film is reduced when the content of the cobalt-containing substance is decreased.

The present inventors obtained the following knowledge as a result of the investigation.
(1) When a chemical conversion treatment solution containing an aqueous cobalt-containing substance further contains a pyrogallol compound as an elution inhibitor, a chemical conversion film formed from the chemical conversion treatment solution has a high degree of corrosion resistance and an excellent appearance, and the amount of elution of hexavalent chromium is markedly reduced.
(2) A chemical conversion treatment solution containing a pyrogallol compound has a higher stability than a chemical conversion treatment solution containing an elution inhibitor other than a pyrogallol compound. Specifically, the chemical conversion treatment solution containing a pyrogallol compound is less likely to have an insoluble component and a decomposition product or by-product.
(3) When a chemical conversion treatment solution containing a pyrogallol compound further contains an organophosphonate compound, a chemical conversion film formed from the solution has a high degree of corrosion resistance and an excellent appearance, and the amount of elution of hexavalent chromium is markedly reduced, even if the content of the pyrogallol compound or the aqueous cobalt-containing substance in the solution is relatively decreased.

One aspect of the present invention achieved based on the above-mentioned knowledge is a composition for chemical conversion treatment characterized by comprising, based on the total composition, 0.1 g/L to 3.0 g/L of an aqueous cobalt-containing substance in cobalt equivalent, 0.05 g/L to 3.0 g/L of a pyrogallol compound in pyrogallol equivalent, and at least 1.5 g/L of an aqueous trivalent chromium-containing substance in chromium equivalent, the composition being acidic and the ratio of the content of the pyrogallol compound in pyrogallol equivalent to the content of the aqueous cobalt-containing substance in cobalt equivalent being 0.015 to 10, wherein a chemical conversion film formed on a metallic surface of a member by contacting the metallic surface with the composition for chemical conversion treatment has a content of hexavalent chromium of 0.050 μg/cm² or less as measured by a method compliant with EN15205 after exposure to an environment having a temperature of 80 degrees C. and a relative humidity of 100% for 72 hours.

Another aspect of the present invention is a composition for chemical conversion treatment characterized by comprising, based on the total composition, 1.0 g/L to 3.0 g/L of an aqueous cobalt-containing substance in cobalt equivalent, at most 1.0 g/L of a pyrogallol compound in pyrogallol equivalent, at least 1.5 g/L of an aqueous trivalent chromium-containing substance in chromium equivalent, and an organophosphonate compound in an amount such that the ratio of the content of the organophosphonate compound to the content of the pyrogallol compound in pyrogallol equivalent is more than 10 and preferably at least 15, the composition being acidic and the ratio of the content of the pyrogallol compound in pyrogallol equivalent to the content of the aqueous cobalt-containing substance in cobalt equivalent being 0.1 to 10, wherein a chemical conversion film formed on a metallic surface of a member by contacting the metallic surface with the composition for chemical conversion treatment has a content of hexavalent chromium of 0.030 μg/cm² or less as measured by a method compliant with EN15205 after exposure to an environment having a temperature of 80 degrees C. and a relative humidity of 100% for 216 hours.

A further aspect of the present invention is a composition for chemical conversion treatment characterized by comprising, based on the total composition, at least 0.1 g/L and less than 1.0 g/L of an aqueous cobalt-containing substance in cobalt equivalent, at most 1.0 g/L of a pyrogallol compound in pyrogallol equivalent, at least 1.5 g/L of an aqueous trivalent chromium-containing substance in chromium equivalent, and an organophosphonate compound in an amount such that the ratio of the content of the organophosphonate compound to the content of the aqueous cobalt-containing substance in cobalt equivalent is more than 10 and preferably at least 12.5, the composition being acidic and the ratio of the content of the pyrogallol compound in pyrogallol equivalent to the content of the aqueous cobalt-containing substance in cobalt equivalent being 0.1 to 10, wherein a chemical conversion film formed on a metallic surface of a member by contacting the metallic surface with the composition for chemical conversion treatment has a content of hexavalent chromium of 0.030 μg/cm² or less as measured by a method compliant with EN15205 after exposure to an environment having a temperature of 80 degrees C. and a relative humidity of 100% for 216 hours, and the area of the chemical conversion film on which white rust is formed after a 192-hour salt spray test compliant with JIS H 8502 is less than 5% of the total area of the chemical conversion film.

The present invention further provides a method of producing a member having a chemical conversion film on the surface of the member characterized in that a metallic surface of the member is contacted with one of the above-described compositions for chemical conversion treatment.

The present invention yet further provides a liquid composition for producing a composition for chemical conversion treatment of a metallic surface of a member.

Examples of the liquid composition include a composition comprising, based on the total composition, 0.5 g/L to 60 g/L of an aqueous cobalt-containing substance in cobalt equivalent, 0.25 g/L to 60 g/L of a pyrogallol compound in pyrogallol equivalent, and at least 7.5 g/L of an aqueous trivalent chromium-containing substance in chromium equivalent, wherein the ratio of the content of the pyrogallol compound in pyrogallol equivalent to the content of the aqueous cobalt-containing substance in cobalt equivalent is 0.015 to 10.

Examples of the liquid composition also include a composition comprising, based on the total composition, 5 g/L to 60 g/L of an aqueous cobalt-containing substance in cobalt equivalent, at most 20 g/L of a pyrogallol compound in pyrogallol equivalent, at least 7.5 g/L of an aqueous trivalent chromium-containing substance in chromium equivalent, and an organophosphonate compound in an amount such that the ratio of the content of the organophosphonate compound to the content of the pyrogallol compound in pyrogallol equivalent is more than 10 and preferably at least 15, wherein the composition is acidic and the ratio of the content of the pyrogallol compound in pyrogallol equivalent to the content of the aqueous cobalt-containing substance in cobalt equivalent is 0.1 to 10.

Examples of the liquid composition further include a composition comprising, based on the total composition, at least 0.5 g/L and less than 20 g/L of an aqueous cobalt-containing substance in cobalt equivalent, at most 20 g/L of a pyrogallol compound in pyrogallol equivalent, at least 7.5 g/L of an aqueous trivalent chromium-containing substance in chromium equivalent, and an organophosphonate compound in an amount such that the ratio of the content of the organophosphonate compound to the content of the aqueous cobalt-containing substance in cobalt equivalent is more than 10 and preferably at least 12.5, wherein the composition is acidic and the ratio of the content of the pyrogallol compound in pyrogallol equivalent to the content of the aqueous cobalt-containing substance in cobalt equivalent is 0.1 to 10.

According to the present invention, the amount of elution of hexavalent chromium from a chemical conversion film having a high degree of corrosion resistance and an excellent appearance obtained from a chemical conversion treatment solution containing an aqueous trivalent chromium-containing substance and an aqueous cobalt-containing substance can be at a especially low level even after the chemical conversion film is stored in a high-temperature and high-humidity environment.

### BRIEF DESCRIPTION OF THE DRAWINGS

FIG. 1 is a graph showing the results of test numbers 1-1 to 1-12 of Example 1.

### BEST MODE FOR CARRYING OUT THE INVENTION

### 1. Composition for Chemical Conversion Treatment

A composition for chemical conversion treatment (a chemical conversion treatment solution) according to the present invention is an acidic composition comprising, 0.1 g/L to 3.0 g/L of an aqueous cobalt-containing substance in cobalt equivalent, 0.05 g/L to 3.0 g/L of a pyrogallol compound in pyrogallol equivalent, and at least 1.5 g/L of an aqueous trivalent chromium-containing substance in chromium equivalent, the composition being acidic and the ratio of the content of the pyrogallol compound in pyrogallol equivalent to the content of the aqueous cobalt-containing substance in cobalt equivalent being 0.015 to 10.

A chemical conversion film having properties such that elution of hexavalent chromium from the film is inhibited and such that the degree of corrosion resistance of the film is excellent is formed by contacting the chemical conversion treatment solution according to the present invention with a member having a metallic surface. It is impossible to specify the treatment temperature for all conditions because the temperature depends on the content of components in the chemical conversion treatment solution or the pH of the chemical conversion treatment solution. It is preferable that the contacting period of the member with the chemical conversion treatment solution be 10 seconds or more when the temperature of the chemical conversion treatment is 20 degrees C. or more, and that the period of contact be 5 to 50 seconds when the temperature of the chemical conversion treatment is 40 degrees C. or more. Any means can be employed for contacting the member with the chemical conversion treatment solution. Examples of the means for contacting include immersion of a member having a metallic surface in the chemical conversion treatment solution according to the present invention and spraying the chemical conversion treatment solution onto the member.

Components of the chemical conversion treatment solution according to the present invention will next be described.

### (1) Aqueous Trivalent Chromium-Containing Substance

The chemical conversion treatment solution according to the present invention contains at least one aqueous trivalent chromium-containing substance. The aqueous trivalent chromium-containing substance is selected from the group consisting of trivalent chromium and aqueous substances containing trivalent chromium. Examples of the aqueous trivalent chromium-containing substance include Cr[H₂O]₆³⁺.

A substance added to the chemical conversion treatment solution so that the solution contains an aqueous trivalent chromium-containing substance, namely, a source reagent for the aqueous trivalent chromium-containing substance, is preferably an aqueous compound capable of forming trivalent chromium in water, which is referred to below as an aqueous trivalent chromium compound.

Examples of the aqueous trivalent chromium compound include a salt of trivalent chromium such as chromium chloride, chromium sulfide, chromium nitride, chromium phosphate, and chromium acetate. Examples of the aqueous trivalent chromium compound also include a compound having trivalent chromium, which is formed by the reduction of a hexavalent chromium compound such as chromic acid and a dichromate. The aqueous trivalent chromium compound may consist of a single species or of multiple species. The chemical conversion treatment solution according to the present invention does not substantially contain hexavalent chromium because a hexavalent chromium compound is not added to a chemical conversion treatment solution according to the present invention as a source reagent.

The content of the aqueous trivalent chromium compound is preferably at least 1.5 g/L in chromium equivalent. There is no limitation on the upper limit of the content. It is preferable that the content be at most 7 g/L, since there is a possibility of problems from the viewpoint of economic efficiency or waste disposal.

### (2) Aqueous Cobalt-Containing Substance

The chemical conversion treatment solution according to the present invention contains at least one aqueous cobalt-containing substance. The aqueous cobalt-containing substance is selected from the group consisting of a cobalt ion and aqueous substances containing a cobalt ion. Examples of the aqueous cobalt-containing substance include Co[H₂O]₆²⁺, and a complex compound of a cobalt ion and a carboxylic acid compound.

A substance added to the chemical conversion treatment solution so that the solution contains an aqueous cobalt-containing substance, namely, a source reagent for the aqueous cobalt-containing substance, is preferably an aqueous compound capable of forming a cobalt ion in water, which is referred to below as an aqueous cobalt compound.

Examples of the aqueous cobalt compound include a salt of cobalt such as cobalt chloride, cobalt sulfide, cobalt nitride, cobalt phosphate, and cobalt acetate. The aqueous cobalt compound may consist of a single species or of multiple species.

The content of the aqueous cobalt compound is preferably at most 3.0 g/L in cobalt equivalent. When the content is more than 3.0 g/L, there is a possibility of the effect of improving the degree of corrosion resistance obtained by the addition of the aqueous cobalt compound being inferior to the effect of increasing the amount of elution of hexavalent chromium even when a pyrogallol compound, the details of which will be explained below, is co-added. Therefore, the content of the aqueous cobalt compound is preferably at most 3.0 g/L and more preferably at most 1.5 g/L in cobalt equivalent. It is preferable that the content be as small as possible as long as the desired degree of corrosion resistance is achieved. When a member having a chemical conversion film obtained from a chemical conversion treatment solution containing an aqueous cobalt compound is used as a general-purpose member, the content of the aqueous cobalt compound in the solution is preferably at least 0.1 g/L in cobalt equivalent. The ratio of the area on which white rust is formed to the total area of the member can be at most 5% even after a 120-hour salt spray test compliant with JIS H 8502. The content of the aqueous cobalt compound is preferably at least 0.3 g/L in cobalt equivalent so that the above-described degree of corrosion resistance is stably achieved. When a member is used for a purpose demanding a high degree of corrosion resistance like for an automotive part, the content of the aqueous cobalt compound is preferably at least 0.5 g/L in cobalt equivalent. When there is an especially strong demand for a high degree of corrosion resistance, the content is preferably at least 1.0 g/L in cobalt equivalent.

### (3) Pyrogallol Compound

The chemical conversion treatment solution according to the present invention contains a pyrogallol compound so as to inhibit elution of hexavalent chromium from a chemical conversion film obtained from the chemical conversion treatment solution. In the present invention, a pyrogallol compound means one or more compounds selected from pyrogallol and alkyl pyrogallols having at most 3 carbon atoms in the alkyl group. These alkyl pyrogallols such as 5-methylpyrogallol or 5-ethylpyrogallol have similar properties to pyrogallol.

The pyrogallol compound has an especially high performance in inhibiting elution of hexavalent chromium when a chemical conversion treatment solution also contains an aqueous cobalt-containing substance. The pyrogallol compound has a higher degree of solubility in a chemical conversion treatment solution and a lower possibility of forming by-products than other triphenol compounds such as gallic acid. Furthermore, the pyrogallol compound has a lower possibility of degrading the appearance of a chemical conversion film obtained from the chemical conversion treatment solution than other triphenol compounds.

The reason why the amount of elution of hexavalent chromium from a chemical conversion film obtained from a chemical conversion treatment solution containing an aqueous cobalt-containing substance is reduced when a pyrogallol compound is contained in the chemical conversion treatment solution is not clear. A reducing agent directly interacts with hexavalent chromium. In contrast, there is a possibility of a pyrogallol compound not directly interacting with hexavalent chromium but inhibiting the elution of hexavalent chromium caused by the interaction between a cobalt ion and trivalent chromium, for example, through the coordination of a pyrogallol compound with a cobalt ion.

The content of the pyrogallol compound in the chemical conversion treatment solution according to the present invention is 0.05 g/L to 3.0 g/L. When the chemical conversion treatment solution contains at least 0.05 g/L of the pyrogallol compound, elution of hexavalent chromium from a chemical conversion film formed from the chemical conversion treatment solution is stably reduced such that the film has a content of hexavalent chromium of 0.050 μg/cm² or less as measured by a method compliant with EN15205 after exposure to an environment having a temperature of 80 degrees C. and a relative humidity of 100% for 72 hours. When the content is more than 3.0 g/L, the appearance of the formed chemical conversion film becomes dark yellow or brownish, and an insoluble component is relatively readily formed in a dense solution of the chemical conversion treatment solution, the details of which will be explained later.

In addition, the ratio of the content of the pyrogallol compound in pyrogallol equivalent to the content of the aqueous cobalt-containing substance in cobalt equivalent, which will be referred to below as the Pr/Co ratio, is at most 10, so as to achieve an excellent appearance of the formed chemical conversion film. The relation between the Pr/Co ratio and the appearance of the formed film is not clear. It is thought that when the Pr/Co ratio of a chemical conversion treatment solution is excessive, the content of a pyrogallol compound not interacting with the aqueous cobalt-containing substance increases in the chemical conversion treatment solution or in a chemical conversion film formed from the solution, and this free pyrogallol compound degrades the appearance of the formed film. The Pr/Co ratio is preferably at least 0.015 so that the above-described effect of reducing the elution of hexavalent chromium of the pyrogallol compound is stably obtained.

It is preferable in view of inhibiting the effect of by-products that the content of the pyrogallol compound in the chemical conversion treatment solution become lower as the area of the chemical conversion film which is formed increases, namely, as aging of the chemical conversion treatment solution progresses.

Only when a pyrogallol compound is contained in a chemical conversion treatment solution containing an aqueous cobalt-containing substance, elution of hexavalent chromium from a chemical conversion film obtained from the solution can be inhibited and the film has both a high degree of corrosion resistance and excellent appearance. A chemical conversion treatment film having both a high degree of corrosion resistance and excellent appearance is hardly obtained from a chemical conversion treatment solution containing an aqueous cobalt-containing substance and a compound having a triphenol structure other than a pyrogallol compound.

Examples of such a compound other than a pyrogallol compound include gallic acid. When gallic acid is used as an elution inhibitor, the amount of hexavalent chromium eluting from a chemical conversion film obtained from a chemical conversion treatment solution containing gallic acid and an aqueous cobalt-containing substance is more than the amount of hexavalent chromium eluting from a chemical conversion film obtained from a chemical conversion treatment solution in which a pyrogallol compound is contained instead of gallic acid, the content of the pyrogallol compound is the same as the content of the replaced gallic acid, and the content of the aqueous cobalt-containing substance in cobalt equivalent is the same as the content of the aqueous cobalt-containing substance in cobalt equivalent in the chemical conversion treatment solution containing gallic acid. The tendency for the amount of eluting hexavalent chromium to increase is marked as the length of exposure to an environment having a high temperature and high humidity increases. In addition, the appearance of a chemical conversion film is markedly degraded when gallic acid is used as an elution inhibitor. Therefore, the ratio of the content of gallic acid to the content of an aqueous cobalt-containing substance in cobalt equivalent must be less than 0.5 so as to obtain an excellent appearance of the chemical conversion film formed from a chemical conversion treatment solution in which gallic acid is used as an elution inhibitor. Accordingly, it is impossible for the chemical conversion film formed from a chemical conversion treatment solution containing gallic acid as an elution inhibitor to have both a high degree of corrosion resistance and excellent appearance.

The ratio of the molar content of trivalent chromium to the molar content of the pyrogallol compound is preferably 1 to 200 and more preferably 4 to 50 so that chemical conversion treatment is stably performed.

### (4) Organophosphonate Compound

The chemical conversion treatment solution according to the present invention may contain an organophosphonate compound.

The term “organophosphonate compound” according to the present invention is defined as one or more compounds selected from the group consisting of organophosphonic acids, ions of the acids, and salts of the acids. The term “organophosphonic acid” is defined as a compound which consists of a phosphonic group and an organic group bonding with the phosphonic group. It has the general formula R—P(═O)(OH)₂, where R is an organic group.

Examples of organophosphonic acids include (1-Hydroxyethane-1,1-diyl)bisphosphonic acid, 2-Phosphonobutane1,2,4-tricarboxylic acid, aminotrimethylenephosphonic acid, ethylenediaminetetramethylenephosphonic acid, and diethylenetriaminepentamethylenephosphonic acid.

Examples of salts of the above-described acids include tetrasodium (1-Hydroxyethane-1,1-diyl)bisphosphonate, trisodium (1-Hydroxyethane-1,1-diyl)bisphosphonate, pentasodium ethylenediaminetetramethylenephosphonate, and heptasodium diethylenetriaminepentamethylenephosphonate. It is often the case that sodium ions contained in the salts are separated from organic phosphonate ions in a chemical conversion treatment solution.

A chemical conversion treatment solution containing the above-described organophosphonate compound can form a chemical conversion film having properties such that the amount of elution of hexavalent chromium is reduced even when the formed film is stored in an environment having a high temperature and high humidity. In addition, the formed film has both an especially high degree of corrosion resistance and an extremely good appearance.

The organophosphonate compound has the following two functions. The first function is to enhance the ability of the pyrogallol compound to reduce the amount of elution of hexavalent chromium from a chemical conversion film. The second function is to enhance the ability of the aqueous cobalt-containing substance to improve corrosion resistance. The first function of the organophosphonate compound is referred to as “enhancement of elution inhibition” and the second function is referred to as “enhancement of corrosion resistance”. Two chemical conversion treatment solutions having different compositions are provided, with each solution having a different one of the functions due to its composition.

### (i) Composition Based on the Enhancement of Elution Inhibition

The following composition is one which enhances elution inhibition. The composition is acidic and comprises, based on the total composition, 1.0 g/L to 3.0 g/L of an aqueous cobalt-containing substance in cobalt equivalent, at most 1.0 g/L of a pyrogallol compound in pyrogallol equivalent, at least 1.5 g/L of an aqueous trivalent chromium-containing substance in chromium equivalent, and an organophosphonate compound in an amount such that the ratio of the content of the organophosphonate compound to the content of the pyrogallol compound in pyrogallol equivalent is more than 10 and preferably at least 15, and such that the ratio of the content of the pyrogallol compound in pyrogallol equivalent to the content of the aqueous cobalt-containing substance in cobalt equivalent is 0.1 to 10. The above-described chemical conversion not containing an organophosphonate compound is referred to below as chemical conversion treatment solution 1, and the chemical conversion treatment solution which is prepared so as to enhance elution inhibition by adding the organophosphonate compound is referred to below as chemical conversion treatment solution 2.

The content of the pyrogallol compound in chemical conversion treatment solution 2 is relatively low since the organophosphonate compound enhances elution inhibition. The pyrogallol compound has a low possibility of degrading the appearance of the chemical conversion film compared to other triphenol compounds such as gallic acid and tannic acid. However, when the content of the pyrogallol compound is excessive, the possibility of a degradation in appearance increases. Therefore, one possible approach for obtaining a chemical conversion film having both an especially high degree of corrosion resistance and an extremely good appearance is to reduce the content of the pyrogallol compound in a chemical conversion treatment solution to the extent possible. In addition, when the content of the pyrogallol compound is excessive in a chemical conversion treatment solution, the possibility of precipitation of the pyrogallol compound in a dense solution for preparing the chemical conversion treatment solution, the details of which will be explained below, or the possibility of formation of insoluble by-products in the chemical conversion treatment solution is increased. From these viewpoints, it is preferable to decrease the content of the pyrogallol compound to the extent possible.

In particular, the content of the pyrogallol compound in chemical conversion treatment solution 2 is at most 1.0 g/L in pyrogallol equivalent. Since the lower limit of the Pr/Co ratio of chemical conversion treatment solution 2 is 0.1 and the lower limit of the content of the aqueous cobalt-containing substance of this solution is 1.0 g/L, the lower limit of the content of the pyrogallol compound in chemical conversion treatment solution 2 is 0.1 g/L in pyrogallol equivalent. Since the content of the pyrogallol compound in chemical conversion treatment solution 1 which does not contain the organophosphonate compound is 0.05 g/L to 3.0 g/L in pyrogallol equivalent, the maximum content of the pyrogallol compound in chemical conversion treatment solution 2 is one third of the maximum content of the pyrogallol compound in chemical conversion treatment solution 1.

The content of the organophosphonate compound in chemical conversion treatment solution 2 is determined so that the ratio of the content of the organophosphonate compound to the content of the pyrogallol compound in pyrogallol equivalent, which is referred to below as the OP/Pr ratio, is more than 10 and preferably at least 15. When the OP/Pr ratio is 10 or less, there is a possibility that the organophosphonate compound cannot stably enhance elution inhibition. When elution inhibition is insufficiently enhanced, the amount of elution of hexavalent chromium from a chemical conversion film is increased.

When the OP/Pr ratio is more than 10 and preferably at least 15 the aqueous cobalt-containing substance is 1.0 g/L to 3.0 g/L in cobalt equivalent, and the Pr/Co ratio is 0.1 to 10, a chemical conversion film formed on a metallic surface of a member by contacting the metallic surface with chemical conversion treatment solution 2 stably has a content of hexavalent chromium of 0.030 μg/cm² or less as measured by a method compliant with EN15205 after exposure to an environment having a temperature of 80 degrees C. and a relative humidity of 100% for 216 hours.

As explained above, chemical conversion treatment solution 2 prepared so as to enhance elution inhibition can sufficiently reduce the amount of elution of hexavalent chromium even when the content of the pyrogallol compound is lower than the content of chemical conversion treatment solution 1.

### (ii) Composition Based on the Enhancement of Corrosion Resistance

The following composition is one which enhances corrosion resistance. The composition is acidic and comprises, based on the total composition, at least 0.1 g/L and less than 1.0 g/L of an aqueous cobalt-containing substance in cobalt equivalent, at most 1.0 g/L of a pyrogallol compound in pyrogallol equivalent, at least 1.5 g/L of an aqueous trivalent chromium-containing substance in chromium equivalent, and an organophosphonate compound in an amount such that the ratio of the content of the organophosphonate compound to the content of the aqueous cobalt-containing substance in cobalt equivalent is more than 10 and preferably at least 12.5, and the ratio of the content of the pyrogallol compound in pyrogallol equivalent to the content of the aqueous cobalt-containing substance in cobalt equivalent is 0.1 to 10. This chemical conversion treatment solution which is prepared so as to enhance corrosion resistance by adding the organophosphonate compound is referred to below as chemical conversion treatment solution 3.

The content of the aqueous cobalt-containing substance in chemical conversion treatment solution 3 is relatively low since the organophosphonate compound enhances corrosion resistance. Since the aqueous cobalt-containing substance has a function of promoting the elution of hexavalent chromium from a chemical conversion film formed from a chemical conversion treatment solution containing the aqueous cobalt-containing substance, the content of the aqueous cobalt-containing substance is preferably low. However, since the aqueous cobalt-containing substance has a function of promoting the corrosion resistance of the obtained chemical conversion film, it is very difficult for a chemical conversion treatment solution used for producing parts for which a high degree of corrosion resistance is required such as parts for vehicles to be free of the aqueous cobalt-containing substance. Therefore, another possible approach for obtaining a chemical conversion film having both an especially high degree of corrosion resistance and an extremely good appearance is to reduce the content of the aqueous cobalt-containing substance in a chemical conversion treatment solution to the extent possible and to add to the chemical conversion treatment solution a component capable of improving corrosion resistance. In addition, an aqueous cobalt compound which is a source material of an aqueous cobalt-containing substance is relatively expensive in comparison with other starting materials of a chemical conversion treatment solution. Therefore, the cost competitiveness of the chemical conversion treatment solution is strengthened by reducing the usage of the aqueous cobalt-containing substance. From these viewpoints, it is preferable that the content of the aqueous cobalt-containing substance be as low as possible.

In particular, the content of the aqueous cobalt-containing substance in chemical conversion treatment solution 3 is at least 0.1 g/L and less than 1.0 g/L in cobalt equivalent. Since the content of the aqueous cobalt-containing substance in cobalt equivalent in chemical conversion treatment solution 1 without an organophosphonate compound is 0.1 g/L to 3.0 g/L in cobalt equivalent, the maximum content of the aqueous cobalt-containing substance in chemical conversion treatment solution 3 is one third of the maximum content of the aqueous cobalt-containing substance in chemical conversion treatment solution 1. Since the lower limit of the Pr/Co ratio of chemical conversion treatment solution 3 is 0.1 and the lower limit of the content of the aqueous cobalt-containing substance of this solution is 0.1 g/L in cobalt equivalent, the lower limit of the content of the pyrogallol compound in pyrogallol equivalent in chemical conversion treatment solution 3 is 0.01 g/L.

The content of the organophosphonate compound in chemical conversion treatment solution 3 is determined so that the ratio of the content of the organophosphonate compound to the content of the aqueous cobalt-containing substance in cobalt equivalent, which is referred to below as the OP/Co ratio, is more than 10 and preferably at least 12.5. When the OP/Co ratio is 10 or less, there is a possibility that the organophosphonate compound cannot stably enhance corrosion resistance. When corrosion resistance is insufficiently enhanced, the degree of corrosion resistance of a chemical conversion film is decreased.

When the OP/Co ratio is more than 10 and preferably at least 12.5, the content of the aqueous cobalt-containing substance in cobalt equivalent is at least 0.1 g/L and less than 1.0 g/L, and the Pr/Co ratio is 0.1 to 10, a chemical conversion film formed on a metallic surface of a member by contacting the metallic surface with the chemical conversion treatment solution 3 stably has a content of hexavalent chromium of 0.030 μg/cm² or less as measured by a method compliant with EN15205 after exposure to an environment having a temperature of 80 degrees C. and a relative humidity of 100% for 216 hours. In addition, the area of the chemical conversion film obtained from chemical conversion treatment solution 3 on which white rust is formed after a 192-hour salt spray test compliant with JIS H 8502 is less than 5% of the total area of the chemical conversion film.

As explained above, chemical conversion treatment solution 3 prepared so as to enhance corrosion resistance of the organophosphonate compound can further increase the degree of corrosion resistance even when the content of the aqueous cobalt-containing substance is reduced in comparison to chemical conversion treatment solution 1.

### (5) Other Components

The chemical conversion treatment solution according to the present invention can also contain one or more compounds selected from the group consisting of metal ions, an organic acid and an anion of the acid, an inorganic acid and an anion of the acid, an inorganic colloid, a silane coupling agent, a sulfur compound, and a fluorine compound. The chemical conversion treatment solution can further contain one or more compounds selected from the group consisting of a polymer such as wax, a corrosion inhibitor, a surfactant such as a diol, a triol, and an amine, a plastic dispersive material, a colorant, a pigment, a pigment-producing agent such as a metal pigment-producing agent, a desiccant, and a dispersant.

Examples of the metal ion include an ion of Ni, Na, K, Ag, Au, Ru, Nb, Ta, Pt, Pd, Fe, Ca, Mg, Zr, Sc, Ti, Mn, Cu, Zn, Sn, Y, Mo, Hf, V, and W. The metal ion can exist in the form of an oxygen acid ion such as a tungstate ion.

Examples of the organic acid include a monocarboxylic acid such as formic acid, acetic acid, and propionic acid; a dicarboxylic acid such as oxalic acid, malonic acid, succinic acid, glutaric acid, adipic acid, pimelic acid, suberic acid, azelaic acid, sebacic acid, maleic acid, phthalic acid, and terephthalic acid; a tricarboxylic acid such as tricarballylic acid; a hydroxycarboxyl acid such as glycolic acid, lactic acid, malic acid, tartaric acid, citric acid, and ascorbic acid; and an aminocarboxylic acid such as glycine and alanine.

Examples of the inorganic acid include a halogen acid such as hydrochloric acid, hydrofluoric acid, and hydrobromic acid, chloric acid, perchloric acid, chlorite acid, hypochlorous acid, sulfuric acid, sulfurous acid, nitric acid, nitrous acid, phosphoric acid (orthophosphoric acid), polyphosphoric acid, metaphosphoric acid, pyrophosphoric acid, ultraphosphoric acid, hypophosphorous acid, and perphosphoric acid. It is preferable that one or more compound selected from the group consisting of a halogen acid, sulfuric acid, nitric acid, and phosphoric acid (orthophosphoric acid) be contained in the form of an anion.

There is no limitation on the contents of the above-described acids and/or ions of the acids. Generally speaking, the ratio of the total molar content of these acid components to the total molar content of trivalent chromium and the above-described metal ions is in the range of 0.1 to 10, and it is preferable that the ratio be in the range of 0.5 to 3.

Examples of the inorganic colloid include a silica sol, an alumina sol, a titanium sol, and a zirconium sol. Examples of the silane coupling agent include vinyltriethoxy silane and gamma-metacryloxypropyltrimethoxy silane.

Examples of the sulfur compound include sulfurous acid and sulfite, disulfurous acid and disulfite, and an organic or inorganic compound containing —SH (mercapto group), —S— (thioether group), >C═S (thioaldehyde group, thioketone group), —COSH (thiocarboxy group, —CSSH (dithiocarboxy group), —CSNH₂ (thioamide group), and/or —SCN (thiocyanate group, isocyanate group). Specific examples of such an organic or inorganic compound include ammonium thioglycolate, thioglycolic acid, thiomaleic acid, thioacetamide, dithioglycolic acid, ammonium dithioglycolate, ammonium dithiodiglycolate, dithiodiglycolic acid, cysteine, saccharin, thiamine nitrate, sodium N,N-diethyl-dithiocarbamate, 1,3-diethyl-2-thiourea, N-thiazole-2-sulfuramylamide, 1,2,3-benzotriazole, 2-thiazolin-2-thiol, thiazole, thiourea, thiozole, sodium thioindoxylate, o-sulfonamidobenzoic acid, sulfanilic acid, orange-II, methyl orange, naphthionic acid, naphtalene-alpha-sulfonic acid, 2-mercaptobenzothiazole, 1-naphthol-4-sulfonic acid, Schaeffer's acid (6-hydroxy-2-Naphthalenesulfonic acid), sulfadiazine, ammonium thiocyanate, potassium thiocyanate, sodium thiocyanate, rhodanine, ammonium sulfide, sodium sulfide, ammonium sulfate, thioglycerin, thioacetic acid, potassium thioacetate, thiodiacetic acid, 3,3-thiodipropionic acid, sodium nitrobenzene sulfonate, and thiosemicarbazide.

### (6) pH and Solvent

The solvent of the chemical conversion treatment solution according to the present invention comprises mainly water. An organic solvent having a high degree of solubility in water such as alcohols, ethers, and ketenes may be contained in the solvent so as to increase the degree of solubility of a pyrogallol compound in the chemical conversion treatment solution. When such an organic solvent is contained in the solvent, the ratio of the content of the organic solvent to the whole solvent is 10% by volume or less in view of imparting the stability to the chemical conversion treatment solution.

The chemical conversion treatment solution is acidic so that chemical conversion sufficiently proceeds and hence the pH of the chemical conversion treatment solution is less than 7. The pH is preferably 1 to 3 in view of imparting the stability to the chemical conversion treatment solution, and the pH is more preferably 1.5 to 2.5.

### 2. Dense Composition for Preparing the Chemical Conversion Treatment Solution

It is preferable to prepare an aqueous composition which is concentrated 5 to 20 times as the above-described chemical conversion treatment solution, which may be referred to below as dense solution for chemical conversion treatment, because the dense solution does not require weighing of each component separately and the dense solution is easy to store. When this dense solution is prepared, the upper limit on the content of each of the above-described components of the solution is determined in view of the solubility of the components.

In particular, a composition comprising, based on the total composition, 0.5 g/L to 60 g/L of an aqueous cobalt-containing substance in cobalt equivalent, 0.25 g/L to 60 g/L of a pyrogallol compound in pyrogallol equivalent, and at least 7.5 g/L of an aqueous trivalent chromium-containing substance in chromium equivalent, with the ratio of the content of the pyrogallol compound in pyrogallol equivalent to the content of the aqueous cobalt-containing substance in cobalt equivalent being 0.015 to 10, can easily provide above-mentioned chemical conversion treatment solution 1 by a process of diluting the composition an appropriate number (5 to 20) of times with a solvent, for which water may be normally used.

A composition comprising, based on the total composition, 5 g/L to 60 g/L of an aqueous cobalt-containing substance in cobalt equivalent, at most 20 g/L of a pyrogallol compound in pyrogallol equivalent, at least 7.5 g/L of an aqueous trivalent chromium-containing substance in chromium equivalent, and an organophosphonate compound in an amount such that the ratio of the content of the organophosphonate compound to the content of the pyrogallol compound in pyrogallol equivalent is more than 10 and preferably 15 or more, with the ratio of the content of the pyrogallol compound in pyrogallol equivalent to the content of the aqueous cobalt-containing substance in cobalt equivalent being 0.1 to 10, can easily provide above-mentioned chemical conversion treatment solution 2 by a process of diluting the composition an appropriate number (5 to 20) of times with a solvent, for which water may be normally used.

A composition comprising, based on the total composition, at least 0.5 g/L and less than 20 g/L of an aqueous cobalt-containing substance in cobalt equivalent, at most 20 g/L of a pyrogallol compound in pyrogallol equivalent, at least 7.5 g/L of an aqueous trivalent chromium-containing substance in chromium equivalent, and an organophosphonate compound in an amount such that the ratio of the content of the organophosphonate compound to the content of the aqueous cobalt-containing substance in cobalt equivalent is more than 10 and preferably 12.5 or more, with the ratio of the content of the pyrogallol compound in pyrogallol equivalent to the content of the aqueous cobalt-containing substance in cobalt equivalent being 0.1 to 10, can easily provide above-mentioned chemical conversion treatment solution 3 by a process of diluting the composition an appropriate number (5 to 20) of times with a solvent, for which water may be normally used.

It is especially preferable that the content of the aqueous cobalt-containing substance in the dense solution be 15 g/L to 33 g/L in cobalt equivalent, since the concentration ratio of the dense solution is sufficiently high and there is an especially low possibility of the aqueous cobalt compound which is a source material of an aqueous cobalt-containing substance being precipitated during the storage of the dense solution.

### 3. Method of Measuring Hexavalent Chromium in a Chemical Conversion Film

The content of hexavalent chromium per area of the chemical conversion film according to the present invention is measured by the following method, which is based on a diphenylcarbazide colorimetric method defined by EN (European Norm) 15205:2006.

A specimen is cut so that the area of the chemical conversion film on the specimen is 50±5 cm², and the specimen after cutting is placed into a beaker. The specimen after cutting is left at room temperature in this method while the specimen is heated as pretreatment as specified in EN 15205:2006. 55 ml of water having a conductance of 1 μS/cm or less, which may be obtained by percolation through an ion exchange column or distillation, are placed into the beaker. The upper end of the beaker containing water is covered with a sheet, and the water in the beaker is boiled for 10 minutes without a boiling stone in the beaker. After boiling, the beaker is cooled in air to room temperature, and the cooled specimen is removed from the beaker. The volume of water in the beaker from which the specimen is removed is made 50 ml by appropriate addition of water. 1 ml of 75% orthophosphoric acid and 1 ml of a diphenylcarbazide solution are added to the 50 ml solution. The diphenylcarbazide solution is prepared by dissolving 1.0 g of 1,5-diphenylcarbazide in 70 ml of acetone followed by adding acetone so that the total volume of the solution becomes 100 ml. The diphenylcarbazide solution should be stored in a cool and dark space and used within 4 weeks of preparation. The above-described solution containing phosphoric acid and the diphenylcarbazide solution after standing for 10 minutes is subjected to measurement of absorbance. At the same time, a standard solution is prepared by dissolving 0.113 g of potassium chromate in 1000 ml of water and adding 1 ml of 75% orthophosphoric acid and 1 ml of a diphenylcarbazide solution to the solution containing potassium chromate. The absorbance of the standard solution after standing for ten minutes is measured. The hexavalent chromium content in the specimen solution is calculated based on the absorbance of the standard solution, and the hexavalent chromium content per area of the specimen is estimated from the result of calculation.

The chemical conversion film to be measured is exposed to an environment having a high temperature and high humidity for a period in order to accelerate elution of hexavalent chromium from the chemical conversion film. Exposure to an environment having a high temperature and high humidity is carried out by storing the specimen on which the chemical conversion film is formed in a constant-temperature and constant-humidity oven, the atmosphere in which is kept at a temperature of 80 degrees C. and a relative humidity of 100% for 72 hours. Measuring a chemical conversion film in which the generation of hexavalent chromium is accelerated to some degree as described above makes it possible to evaluate the long-term inhibition of elution. A product containing a member on which a chemical conversion film is formed is sometimes located in an environment having a high temperature and high humidity, such as in Southeast Asia. Therefore, exposure to such an environment having a high temperature and high humidity has not only an aspect of an accelerated test but also an aspect of a real use environment.

When the above-described measurement is performed on a member which is treated by a chemical conversion treatment solution containing the elution inhibitor according to the present invention and the member is exposed to an environment having a high temperature and high humidity, namely, an environment having a temperature of 80 degrees C. and a relative humidity of 100% for 72 hours as pretreatment and then the above-described measurement is performed, a hexavalent chromium content in the chemical conversion film of less than 0.050 pg/cm² is stably achieved.

The hexavalent chromium content in the chemical conversion film obtained from a chemical conversion treatment solution containing can stably be less than 0.050 μg/cm² after 144 hours of exposure, when the content of the pyrogallol compound of the chemical conversion treatment solution is at least 0.05 g/L.

As explained above, the amount of elution of hexavalent chromium from a chemical conversion treatment solution formed from a chemical conversion treatment solution containing a pyrogallol compound can be reduced for a long term even when the film is stored under severe conditions.

The content of hexavalent chromium of a chemical conversion film obtained by chemical conversion treatment which does not employ the pyrogallol compound which is an elution inhibitor according to the present invention, namely, by treatment using a conventional chemical conversion treatment solution is typically 0.10 μg/cm². Therefore, the chemical conversion film according to the present invention can reduce the amount of elution of hexavalent chromium by half in comparison with a conventional chemical conversion film.

When a different method for measuring the content of hexavalent chromium, such as the method defined by JIS H8625 or the so-called VOLVO method, is performed, the measured content of hexavalent chromium is different from the content measured by the above-described method because treatment for elution of hexavalent chromium is different in the different methods. Nevertheless, the content of hexavalent chromium in the chemical conversion film according to the present invention as measured by any measurement method is much lower than the hexavalent chromium content in a conventional chemical conversion film.

4. Member on which Chemical Conversion Treatment is Performed

Any material can be employed for a member on which chemical conversion treatment is performed as long as the member has a metallic surface on which a chromate film formed by a chemical conversion treatment solution containing trivalent chromium can be formed because the chemical conversion treatment according to the present invention relates to inhibition of elution of hexavalent chromium from the chromate film. A preferable material is metal, and a steel plate on which zinc-based plating is formed is especially preferable.

The zinc-based plating may consist of pure zinc or a zinc alloy such as an alloy containing aluminum. The plating may be formed by electroplating or galvanizing, which includes galvanealing.

The above-described member may be subjected to post treatment so as to further reduce the elution of hexavalent chromium or treatment with a finishing agent for improving the degree of corrosion resistance and/or dent resistance after forming a chemical conversion film by treatment with the chemical conversion treatment solution according to the present invention.

### EXAMPLES

Although the present invention will be more specifically described below with respect to examples, the invention should not be considered as being in any way limited to these examples.

### Example 1

Chemical conversion treatment was performed with chemical conversion treatment solutions which were prepared by adding various amounts of an aqueous cobalt compound and a pyrogallol compound to a known chemical conversion treatment solution containing trivalent chromium, and the effect obtained from adding these compounds was evaluated.

### (1) Preparation of Test Plates

Chemical conversion treatment solutions each containing 2.6 g/L of chromium chloride as an aqueous chromium compound, cobalt nitride in an amount shown in Table 1, and an elution inhibitor in an amount shown in Table 1 were prepared. The pH of each solution was adjusted to 2.0 using sodium hydroxide. The cobalt content shown in Table 1 means the content of the added cobalt nitride in cobalt equivalent. The cobalt content shown in Table 1 was equal to the content of the aqueous cobalt-containing substance in cobalt equivalent in each prepared chemical conversion treatment solution, since the added cobalt nitride was completely dissolved in each chemical conversion treatment solution.

A conventional alkali degreasing process was performed on an electrogalvanized steel plate (5 cm×5 cm×1 mm thick, surface area of 50 cm²), and the degreased plate was washed with water, after which the washed plate was immersed in a nitric acid solution (containing 3 ml/L of a 67.5% nitric acid solution, the temperature of the solution being at room temperature, with an immersion period of 10 seconds) in order to activate the surface of the electrogalvanized steel plate. The steel plate after activation was washed with water, after which the washed plate was immersed for 40 seconds in each of the above-described chemical conversion treatment solutions (pH of 2.0), the temperature of which was at kept at 40 degrees C. After the test plate was taken out of the chemical conversion treatment solution, the plate was washed with water (room temperature, 10 seconds) and dried for 10 minutes at a temperature of 80±10 degrees C.

TABLE 1

| | |
|---|---|
| Content of | |
| aqueous cobalt-containing | Elution inhibitor |

| Test | substance in cobalt equivalent | | content |
|---|---|---|---|
| number | (g/L) | species | (g/L) |
| 1-1 | 0.1 | pyrogallol | 0.05 |
| 1-2 | 0.1 | | 1 |
| 1-3 | 0.1 | | 3 |
| 1-4 | 0.5 | | 3 |
| 1-5 | 1 | | 0.05 |
| 1-6 | 1 | | 0.1 |
| 1-7 | 1 | | 1 |
| 1-8 | 1 | | 3 |
| 1-9 | 3 | | 0.05 |
| 1-10 | 3 | | 3 |
| 1-11 | 3 | | 5 |
| 1-12 | 5 | | 5 |
| 1-13 | — | — | — |
| 1-14 | 0.5 | — | — |
| 1-15 | 0.1 | gallic acid | 0.1 |
| 1-16 | 0.5 | | 0.1 |
| 1-17 | 1 | | 0.1 |
| 1-18 | 3 | | 0.2 |
| 1-19 | 0.1 | sodium | 0.05 |
| 1-20 | 0.1 | bisulfite | 0.5 |
| 1-21 | 0.1 | | 1 |
| 1-22 | 0.5 | | 0.05 |
| 1-23 | 1 | | 1 |
| 1-24 | 3 | | 1 |

### (2) Evaluation Method

The following evaluations were performed on the test plates after drying, on the chemical conversion treatment solutions, and on the dense solutions.

### A) Amount of Elution of Hexavalent Chromium

The test plates after drying were stored in an oven in which the temperature was kept at 80 degrees C. and the humidity was kept at 100% RH so as to accelerate the elution of hexavalent chromium from the chemical conversion treatment solution formed on each of the test plates. The content of hexavalent chromium contained in the chemical conversion film formed on each test plate after storage was measured by a method compliant with EN15205.

The evaluation criteria were as follows.

A (excellent): the amount of elution of hexavalent chromium was less than 0.050 μg/cm² when the storage period was 144 hours,

B (good): the amount of elution of hexavalent chromium was less than 0.050 μg/cm² when the storage period was 72 hours, and

C (bad): the amount of elution of hexavalent chromium was 0.050 μg/cm² or more when the storage period was 72 hours.

### B) Corrosion Resistance

A salt spray test compliant with JIS H 8502 was performed, and the surface of each of the test plates was observed every 24 hours to check whether white rust was formed on the surface of the test plate. When white rust was observed with the naked eye on a test plate, the ratio of the area of white rust to the total surface area of the test plate was measured.

The evaluation criteria were as follows.

A (excellent): the ratio of the area of white rust formed on a test plate after a 192-hour test was less than 5%,

B (good): while the ratio of the area of white rust formed on a test plate after a 192-hour test was at least 5%, the ratio of the area of white rust formed on the test plate after a 120-hour test was at most 5%, and

C (bad): the ratio of the area of white rust formed on the test plate after a 120-hour test was more than 5%.

### C) Appearance

The appearance of each test plate was investigated with the naked eye. The evaluation criteria were as follows.

A (excellent): blue to white silver,

B (good): pale yellow to yellow, and

C (bad): brown to dark violet.

### D) Solubility

The solubility of a chemical conversion treatment solution was evaluated by the following criterion based on naked-eye observation of the chemical conversion treatment solution during preparation by the above-described method.

A (good): an elution inhibitor was easily dissolved in the chemical conversion treatment, and

B (bad): an elution inhibitor was not easily dissolved in the chemical conversion treatment.

This evaluation of solubility was also performed on a dense solution, which was 10 times the concentration of the above-described chemical conversion treatment solution by naked-eye observation.

### (3) Evaluation Results

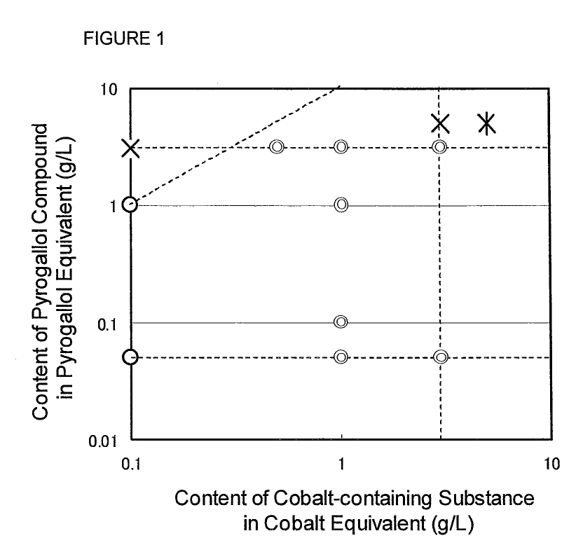

The evaluation results are shown in Table 2. The results obtained from test numbers 1-1 to 1-12 are shown in FIG. 1.

In FIG. 1, the character “⊚” indicates a test plate in which the results for the amount of hexavalent chromium, corrosion resistance, and the appearance were excellent. The character “◯” indicates a test plate in which the results for the amount of hexavalent chromium and the degree of corrosion resistance were excellent, and the result for the evaluation of appearance was good. The character “×” indicates a test plate in which the results for the amount of hexavalent chromium and the degree of corrosion resistance were excellent or good, while the result for the evaluation of appearance was bad. The character “*” indicates a test plate in which the results for the degree of corrosion resistance and the appearance were bad. The results for the amount of elution, the degree of corrosion resistance, and the appearance were good or excellent in test numbers 1-1, 1-2, and 1-4 to 1-10.

The broken lines in FIG. 1 indicate that the content of the aqueous cobalt-containing substance is 3.0 g/L in cobalt equivalent, that the contents of the pyrogallol compound are 0.05 g/L and 3.0 g/L in pyrogallol equivalent, and that the P/Co ratio is 10, respectively. It is clarified by the present Example that the results for the amount of elution, the degree of corrosion resistance, and the appearance of a chemical conversion film formed from a chemical conversion treatment solution are good, when the content of the aqueous cobalt-containing substance in cobalt equivalent and the content of the pyrogallol compound in pyrogallol equivalent in the chemical conversion treatment solution are positioned in the region enclosed by these broken lines and the line indicating that the content of the aqueous cobalt-containing substance is 1.0 g/L in cobalt equivalent, which corresponds to the y axis in FIG. 1.

Regarding the result of the evaluation of solubility, insoluble matter was observed in a dense solution in which the elution inhibitor was gallic acid.

TABLE 2

| | Amount of elution of hexavalent | | | | Evaluation results | | | | |
|---|---|---|---|---|---|---|---|---|---|
| | chromium at 80° C.-100% RH | | | | | | | Solubilitiy in | |
| Test | (μg/cm²) | | | | Amount of | Corrosion | | chemical conversion | Solubilitiy in |
| nunber | 0 hr | 72 hr | 144 hr | 216 hr | elutuion | resistance | Appearance | treatment solutuion | dense solutuion |
| 1-1 | 0.001 | 0.016 | 0.030 | 0.038 | A | B | A | A | A |
| 1-2 | 0.002 | 0.011 | 0.016 | 0.020 | A | B | A | A | A |
| 1-3 | 0.001 | 0.005 | 0.008 | 0.009 | A | B | C | A | A |
| 1-4 | 0.003 | 0.020 | 0.029 | 0.031 | A | A | A | A | A |
| 1-5 | 0.004 | 0.040 | 0.045 | 0.051 | A | A | A | A | A |
| 1-6 | 0.002 | 0.032 | 0.039 | 0.045 | A | A | A | A | A |
| 1-7 | 0.001 | 0.021 | 0.031 | 0.036 | A | A | A | A | A |
| 1-8 | 0.003 | 0.018 | 0.031 | 0.035 | A | A | A | A | A |
| 1-9 | 0.004 | 0.048 | 0.049 | 0.055 | A | A | A | A | A |
| 1-10 | 0.004 | 0.020 | 0.039 | 0.042 | A | A | A | A | A |
| 1-11 | 0.005 | 0.021 | 0.028 | 0.035 | A | B | C | A | A |
| 1-12 | 0.001 | 0.020 | 0.030 | 0.036 | A | C | C | A | A |
| 1-13 | 0.005 | 0.006 | 0.008 | 0.008 | A | C | C | A | A |
| 1-14 | 0.002 | 0.055 | 0.062 | 0.073 | C | A | A | A | A |
| 1-15 | 0.001 | 0.014 | 0.034 | 0.031 | A | B | C | B | B |
| 1-16 | 0.002 | 0.027 | 0.058 | 0.061 | B | A | C | B | B |
| 1-17 | 0.006 | 0.044 | 0.062 | 0.071 | B | A | C | B | B |
| 1-18 | 0.000 | 0.033 | 0.056 | 0.062 | B | A | C | B | B |
| 1-19 | 0.003 | 0.025 | 0.040 | 0.049 | A | B | C | A | A |
| 1-20 | 0.003 | 0.016 | 0.029 | 0.037 | A | B | C | A | A |
| 1-21 | 0.000 | 0.020 | 0.025 | 0.033 | A | C | C | A | A |
| 1-22 | 0.002 | 0.053 | 0.061 | 0.073 | C | A | C | A | A |
| 1-23 | 0.004 | 0.053 | 0.062 | 0.056 | C | C | C | A | A |
| 1-24 | 0.005 | 0.060 | 0.070 | 0.070 | C | C | C | A | A |

### Example 2

Chemical conversion treatment was performed with chemical conversion treatment solutions which were prepared by adding various amounts of a pyrogallol compound and an organophosphonate compound, and 1.0 to 3.0 g/L of an aqueous cobalt compound to a known chemical conversion treatment solution containing trivalent chromium, and the effect obtained from adding these compounds was evaluated.

### (1) Preparation of Test Plates

Chemical conversion treatment solutions each of which contained 2.0 g/L of chromium chloride as an aqueous chromium compound, cobalt nitride, pyrogallol as an elution inhibitor, and (1-Hydroxyethane-1,1-diyl)bisphosphonic acid as an organophoshonate compound, the content of each of which is shown in Table 3, were prepared. The pH of the each solution was adjusted to 2.0 using sodium hydroxide and nitric acid. The cobalt content shown in Table 3 means the cobalt content of the added cobalt nitride in cobalt equivalent. The cobalt content shown in Table 3 was equal to the contents of the aqueous cobalt-containing substance in cobalt equivalent in each prepared chemical conversion treatment solution, since the added cobalt nitride was completely dissolved in each chemical conversion treatment solution.

A conventional alkali degreasing process was performed on an electrogalvanized steel plate (5 cm×5 cm×1 mm thick, surface area of 50 cm²), and the degreased plate was washed with water, after which the washed plate was immersed in a nitric acid solution (containing 3 ml/L of a 67.5% nitric acid solution, the temperature of the solution being at room temperature, with an immersion period of 10 seconds) in order to activate the surface of the electrogalvanized steel plate. The steel plate after activation was washed with water, after which the washed plate was immersed for 40 seconds in the above-described chemical conversion treatment solution (pH was 2.0), the temperature of which was at kept at 40 degrees C. After the test plate was taken out of the chemical conversion treatment solution, the plate was washed with water (room temperature, 10 seconds) and dried for 10 minutes at a temperature of 80±10 degrees C.

TABLE 3

| | Content of | Content of | Content of | | | | | |
|---|---|---|---|---|---|---|---|---|
| | aqueous cobalt-containing | pyrogallol compound | organophosphonate | | | Ratio of the area | | |
| test | substance in cobalt equivalent | in pyrogallol equivalent | compound | Pr/Co | OP/Pr | of white rust (%) | | |
| number | (g/L) | (g/L) | (g/L) | ratio | ratio | 72 hr | 120 hr | 192 hr |
| 2-1 | 1.0 | 0.10 | 0.5 | 0.1 | 5 | 0 | 0 | 10 |
| 2-2 | 1.0 | 0.10 | 1.0 | 0.1 | 10 | 0 | 0 | 10 |
| 2-3 | 1.0 | 0.10 | 1.5 | 0.1 | 15 | 0 | 1 | 5 |
| 2-4 | 1.0 | 0.10 | 2.5 | 0.1 | 25 | 0 | 0 | 10 |
| 2-5 | 1.0 | 0.10 | 5.0 | 0.1 | 50 | 0 | 0 | 5 |
| 2-6 | 1.0 | 0.10 | 7.5 | 0.1 | 75 | 0 | 0 | 0 |
| 2-7 | 1.0 | 0.10 | 10.0 | 0.1 | 100 | 0 | 0 | 0 |
| 2-8 | 1.0 | 0.10 | 20.0 | 0.1 | 200 | 0 | 0 | 0 |
| 2-9 | 3.0 | 0.30 | 3.0 | 0.1 | 10 | 0 | 0 | 0 |
| 2-10 | 3.0 | 0.30 | 4.5 | 0.1 | 15 | 0 | 0 | 0 |
| 2-11 | 3.0 | 0.30 | 10.0 | 0.1 | 33 | 0 | 0 | 0 |
| 2-12 | 3.0 | 0.30 | 15.0 | 0.1 | 50 | 0 | 0 | 0 |
| 2-13 | 1.0 | 0.01 | 5.0 | 0.01 | 500 | 0 | 0 | 10 |
| 2-14 | 1.0 | 0.05 | 5.0 | 0.05 | 100 | 0 | 0 | 5 |
| 2-15 | 1.0 | 0.10 | 5.0 | 0.1 | 50 | 0 | 0 | 5 |
| 2-16 | 1.0 | 0.30 | 5.0 | 0.3 | 17 | 0 | 0 | 1 |
| 2-17 | 1.0 | 1.00 | 5.0 | 1 | 5 | 0 | 0 | 0 |
| 2-18 | 1.0 | 3.00 | 5.0 | 3 | 2 | 0 | 0 | 10 |
| 2-19 | 3.0 | 0.10 | 5.0 | 0.03 | 50 | 0 | 0 | 0 |

| | | Amount of elution of | | | | Evaluation of | |
|---|---|---|---|---|---|---|---|
| | | hexavalent chromium | | | | amount of | |
| | Evaluation of | at 80° C.-100% RH | | | | elution of | Evaluation |
| test | corrosion | (μg/cm²) | | | | hexavalent | of |
| number | resistance | 0 hr | 72 hr | 144 hr | 216 hr | chromium | appearance |
| 2-1 | B | 0.003 | 0.031 | 0.041 | 0.044 | B | A |
| 2-2 | B | 0.006 | 0.008 | 0.010 | 0.033 | B | A |
| 2-3 | B | 0.002 | 0.012 | 0.016 | 0.010 | A | A |
| 2-4 | B | 0.005 | 0.023 | 0.024 | 0.022 | A | A |
| 2-5 | B | 0.010 | 0.013 | 0.009 | 0.010 | A | A |
| 2-6 | A | 0.002 | 0.009 | 0.010 | 0.010 | A | A |
| 2-7 | A | 0.005 | 0.010 | 0.011 | 0.014 | A | A |
| 2-8 | A | 0.005 | 0.008 | 0.007 | 0.009 | A | A |
| 2-9 | A | 0.008 | 0.012 | 0.008 | 0.006 | A | A |
| 2-10 | A | 0.000 | 0.010 | 0.006 | 0.003 | A | A |
| 2-11 | A | 0.008 | 0.013 | 0.012 | 0.012 | A | A |
| 2-12 | A | 0.005 | 0.009 | 0.010 | 0.011 | A | A |
| 2-13 | B | 0.007 | 0.035 | 0.040 | 0.037 | B | A |
| 2-14 | B | 0.006 | 0.032 | 0.033 | 0.033 | B | A |
| 2-15 | B | 0.010 | 0.013 | 0.009 | 0.010 | A | A |
| 2-16 | A | 0.007 | 0.010 | 0.013 | 0.011 | A | A |
| 2-17 | A | 0.008 | 0.009 | 0.009 | 0.010 | A | B |
| 2-18 | B | 0.005 | 0.009 | 0.010 | 0.011 | A | C |
| 2-19 | A | 0.006 | 0.040 | 0.043 | 0.033 | B | A |

### (2) Evaluation Method

The following evaluation was performed on the test plates after drying.

### A) Corrosion Resistance

A salt spray test compliant with JIS H 8502 was performed, and the surface of each of the test plates was observed every 24 hours to check whether white rust was formed on the surface of the test plate. When white rust was observed with the naked eye on a test plate, the ratio of the area of white rust to the total surface area of the test plate was measured.

The evaluation criteria were as follows.

A: the ratio of the area of white rust formed on a test plate after a 192-hour test was less than 5%,

B: while the ratio of the area of white rust formed on a test plate after a 192-hour test was at least 5%, substantially no white rust was observed on the test plate after a 120-hour test,

C: while a substantial amount white rust was observed on the test plate after a 120-hour test, the ratio of the area of white rust was at most 5%, and

D: the ratio of the area of white rust formed on the test plate after a 120-hour test was more than 5%.

It was determined that substantially no white rust was observed on the test plate when the ratio of white rust on a test plate was about 1%. In this condition, there is little possibility of white rust being formed.

### B) Amount of Elution of Hexavalent Chromium

The test plates after drying were stored in an oven in which the temperature was kept at 80 degrees C. and the humidity was kept at 100% RH so as to accelerate the elution of hexavalent chromium from the chemical conversion treatment solution formed on each of the test plates. The content of hexavalent chromium contained in the chemical conversion film formed on each test plate after storage was measured by a method compliant with EN15205.

The evaluation criteria were as follows.

A: the amount of elution of hexavalent chromium was less than 0.030 μg/cm² when the storage period was 216 hours, and

B: the amount of elution of hexavalent chromium was 0.030 μg/cm² or more when the storage period was 216 hours.

### C) Appearance

The appearance of each test plate was investigated with the naked eye. The evaluation criteria were as follows.

A (excellent): blue to white silver,

B (good): pale yellow to yellow, and

C (bad): brown to dark violet.

### (3) Evaluation Results

The evaluation results are shown in Table 3. Although all of these results are evaluated as “good” or “excellent” by the criteria of Example 1, the amount of elution of hexavalent chromium for each of test numbers 2-1, 2-2, 2-13, 2-14, and 2-19 was 0.030 μg/cm² or more after 216 hours of storage, and hence they are evaluated as “B” by the criteria in Example 2. Specifically, the enhancement of elution inhibition of the organophosphonate compound was relatively poor in test numbers 2-1 and 2-2, since the OP/Pr ratio was 10 or less. The function of inhibiting the elution of hexavalent chromium of the pyrogallol compound was relatively poor in test numbers 2-13, 2-14, and 2-19, since the Pr/Co ratio was 0.05 or less.

### Example 3

Chemical conversion treatment was performed with chemical conversion treatment solutions which were prepared by adding various amounts of a pyrogallol compound and an organophosphonate compound, and 0.10 to 0.50 g/L of an aqueous cobalt compound to a known chemical conversion treatment solution containing trivalent chromium, and the effect obtained from adding these compounds was evaluated.

### (1) Preparation of Test Plates

Chemical conversion treatment solutions each of which contained 2.0 g/L of chromium chloride as an aqueous chromium compound, cobalt nitride, pyrogallol as an elution inhibitor, and (1-Hydroxyethane-1,1-diyl)bisphosphonic acid as an organophoshonate compound, the content of each of which is shown in Table 4, were prepared. The pH of the each solution was adjusted to 2.0 using sodium hydroxide and nitric acid. The cobalt content shown in Table 4 means the content of the added cobalt nitride in cobalt equivalent. The cobalt contents shown in Table 4 were equal to the contents of the aqueous cobalt-containing substance in cobalt equivalent in the prepared chemical conversion treatment solutions, since the added cobalt nitride was completely dissolved in each chemical conversion treatment solution.

A conventional alkali degreasing process was performed on an electrogalvanized steel plate (5 cm×5 cm×1 mm thick, surface area of 50 cm²), and the degreased plate was washed with water, after which the washed plate was immersed in a nitric acid solution (containing 3 ml/L of a 67.5% nitric acid solution, the temperature of the solution being at room temperature, with an immersion period of 10 seconds) in order to activate the surface of the electrogalvanized steel plate. The steel plate after activation was washed with water, after which the washed plate was immersed for 40 seconds in the above-described chemical conversion treatment solution (pH was 2.0), the temperature of which was at kept at 40 degrees C. After the test plate taken out of the chemical conversion treatment solution, it was washed with water (room temperature, 10 seconds) and dried for 10 minutes at a temperature of 60±10 degrees C.

TABLE 4

| | Content of | Content of | Content of | | | | | |
|---|---|---|---|---|---|---|---|---|
| | aqueous cobalt-containing | pyrogallol compound | organophosphonate | | | Ratio of the area | | |
| test | substance in cobalt equivalent | in pyrogallol equivalent | compound | Pr/Co | OP/Co | of white rust (%) | | |
| number | (g/L) | (g/L) | (g/L) | ratio | ratio | 72 hr | 120 hr | 192 hr |
| 3-1 | 0.10 | 0.10 | 0.0 | 1 | 0.0 | 5 | 20 | 60 |
| 3-2 | 0.10 | 0.10 | 0.1 | 1 | 0.5 | 0 | 5 | 20 |
| 3-3 | 0.10 | 0.10 | 0.5 | 1 | 5 | 0 | 5 | 20 |
| 3-4 | 0.10 | 0.10 | 1.0 | 1 | 10 | 0 | 5 | 10 |
| 3-5 | 0.10 | 0.10 | 1.5 | 1 | 15 | 0 | 0 | 3 |
| 3-6 | 0.10 | 0.10 | 5.0 | 1 | 50 | 0 | 0 | 0 |
| 3-7 | 0.10 | 0.10 | 10.0 | 1 | 100 | 0 | 0 | 0 |
| 3-8 | 0.10 | 0.10 | 15.0 | 1 | 150 | 0 | 0 | 0 |
| 3-9 | 0.10 | 0.10 | 25.0 | 1 | 250 | 0 | 0 | 0 |
| 3-10 | 0.20 | 0.10 | 0.0 | 0.5 | 0.0 | 0 | 3 | 10 |
| 3-11 | 0.20 | 0.10 | 2.5 | 0.5 | 12.5 | 0 | 0 | 0 |
| 3-12 | 0.20 | 0.10 | 5.0 | 0.5 | 25 | 0 | 0 | 0 |
| 3-13 | 0.20 | 0.10 | 7.5 | 0.5 | 37.5 | 0 | 0 | 3 |
| 3-14 | 0.20 | 0.10 | 15.0 | 0.5 | 75 | 0 | 0 | 0 |
| 3-15 | 0.20 | 0.10 | 25.0 | 0.5 | 125 | 0 | 0 | 0 |
| 3-16 | 0.50 | 0.10 | 7.5 | 0.2 | 15 | 0 | 0 | 0 |
| 3-17 | 0.40 | 0.10 | 0.0 | 0.25 | 0 | 0 | 1 | 10 |
| 3-18 | 0.50 | 0.10 | 0.0 | 0.2 | 0 | 0 | 1 | 5 |
| 3-19 | 0.01 | 0.10 | 10.0 | 10 | 1000 | 5 | 10 | 30 |

| | | Amount of elution of | | | | Evaluation of | |
|---|---|---|---|---|---|---|---|
| | | hexavalent chromium | | | | amount of | |
| | Evaluation of | at 80° C.-100% RH | | | | elution of | |
| test | corrosion | (μg/cm²) | | | | hexavalent | Evaluation of |
| number | resistance | 0 hr | 72 hr | 144 hr | 216 hr | chromium | appearance |
| 3-1 | D | 0.003 | 0.010 | 0.011 | 0.015 | A | A |
| 3-2 | C | 0.002 | 0.006 | 0.010 | 0.010 | A | A |
| 3-3 | C | 0.000 | 0.020 | 0.011 | 0.010 | A | A |
| 3-4 | C | 0.004 | 0.006 | 0.010 | 0.009 | A | A |
| 3-5 | A | 0.005 | 0.006 | 0.003 | 0.005 | A | A |
| 3-6 | A | 0.007 | 0.011 | 0.011 | 0.009 | A | A |
| 3-7 | A | 0.005 | 0.008 | 0.009 | 0.006 | A | A |
| 3-8 | A | 0.009 | 0.003 | 0.010 | 0.006 | A | A |
| 3-9 | A | 0.007 | 0.004 | 0.013 | 0.010 | A | A |
| 3-10 | C | 0.004 | 0.008 | 0.010 | 0.011 | A | A |
| 3-11 | A | 0.003 | 0.004 | 0.016 | 0.013 | A | A |
| 3-12 | A | 0.004 | 0.006 | 0.009 | 0.010 | A | A |
| 3-13 | A | 0.005 | 0.008 | 0.009 | 0.010 | A | A |
| 3-14 | A | 0.003 | 0.008 | 0.011 | 0.010 | A | A |
| 3-15 | A | 0.002 | 0.004 | 0.010 | 0.008 | A | A |
| 3-16 | A | 0.009 | 0.006 | 0.009 | 0.010 | A | A |
| 3-17 | B | 0.003 | 0.007 | 0.013 | 0.013 | A | A |
| 3-18 | B | 0.002 | 0.005 | 0.009 | 0.010 | A | A |
| 3-19 | D | 0.004 | 0.002 | 0.009 | 0.008 | A | A |

### (2) Evaluation Method

The following evaluation was performed on the test plates after drying.

### A) Corrosion Resistance

A salt spray test compliant with JIS H 8502 was performed, and the surface of each of the test plates was observed every 24 hours to check whether white rust was formed on the surface of the test plate. When white rust was observed with the naked eye on a test plate, the ratio of the area of white rust to the total surface area of the test plate was measured.

The evaluation criteria were as follows.

A: the ratio of the area of white rust formed on a test plate after a 192-hour test was less than 5%,

B: while the ratio of the area of white rust formed on a test plate after a 192-hour test was at least 5%, substantially no white rust is observed on the test plate after a 120-hour test,

C: while substantially white rust was observed on the test plate after a 120-hour test, the ratio of the area of white rust was at most 5%, and

D: the ratio of the area of white rust formed on the test plate after a 120-hour test was than 5%.

It was determined that substantially no white rust was observed on the test plate when the ratio of white rust on a test plate was about 1%. In this condition, there is little possibility of white rust being formed.

### B) Amount of Elution of Hexavalent Chromium

The test plates after drying were stored in an oven in which the temperature was kept at 80 degrees C. and the humidity was kept at 100% RH so as to accelerate the elution of hexavalent chromium from the chemical conversion treatment solution formed on each of the test plates. The content of hexavalent chromium contained in the chemical conversion film formed on each test plate after storage was measured by a method compliant with EN15205.

The evaluation criteria were as follows.

A: the amount of elution of hexavalent chromium was less than 0.030 μg/cm² when the storage period was 216 hours, and

B: the amount of elution of hexavalent chromium was 0.030 μg/cm² or more when the storage period was 216 hours.

### C) Appearance

The appearance of each test plate was investigated with the naked eye. The evaluation criteria were as follows.

A (excellent): blue to white silver,

B (good): pale yellow to yellow, and

C (bad): brown to dark violet.

### (3) Evaluation Results

The evaluation results are shown in Table 4. Although all of these results except for test number 3-19 are evaluated as “good” or “excellent” by the criteria in Example 1, white rust was substantially observed on the surface of each of test numbers 3-1 to 3-4, and 3-10 after a 120-hour salt spray test, and hence they are evaluated as “C” by the criteria in Example 3. The enhancement of corrosion resistance of the organophosphonate compound was relatively poor in these test plates, since the OP/Co ratio was 10 or less.

As shown in test numbers 3-17 and 3-18, when the content of the aqueous cobalt-containing substance in cobalt equivalent in a chemical conversion treatment solution is 0.40 g/L or more, a chemical conversion film formed from the chemical conversion treatment solution has corrosion resistance such that white rust is substantially unobserved after a 120-hour salt spray test even when the chemical conversion treatment solution does not contain any organophosphonate compound. These results show that when an organophosphonate compound is contained in a chemical conversion treatment solution, the effect obtained from the organophosphonate compound becomes marked when the content of the aqueous cobalt-containing substance in cobalt equivalent is less than 0.40 g/L.

The result of the evaluation of test number 3-1 was “D”. As shown by this result, when the content of the aqueous cobalt-containing substance in cobalt equivalent is low in a chemical conversion treatment solution free of an organophosphonate compound, the degree of corrosion resistance of a chemical conversion film obtained from the chemical conversion treatment solution becomes unstable and white rust can be formed after a brief salt spray test. Therefore, as explained above, the content of the aqueous cobalt-containing substance in cobalt equivalent in a chemical conversion treatment solution free of an organophosphonate compound is set to be about 0.30 g/L so as to reduce the possibility that the degree of corrosion resistance decreases. However, as shown in the present example, by adding a proper amount of an organophosphonate compound to a chemical conversion treatment solution, a chemical conversion film having a high degree of corrosion resistance can be stably formed from the chemical conversion treatment solution even when the content of the aqueous cobalt-containing substance in cobalt equivalent of the solution is low such as about 0.1 g/L.

1. A composition for chemical conversion treatment comprising, based on the total composition,
0.1 g/L to 3.0 g/L of an aqueous cobalt-containing substance in cobalt equivalent,
0.05 g/L to 3.0 g/L of a pyrogallol compound in pyrogallol equivalent, and
at least 1.5 g/L of an aqueous trivalent chromium-containing substance in chromium equivalent,
the composition being acidic and the ratio of the content of the pyrogallol compound in pyrogallol equivalent to the content of the aqueous cobalt-containing substance in cobalt equivalent being 0.015 to 10,
wherein a chemical conversion film formed on a metallic surface of a member by contacting the metallic surface with the composition for chemical conversion treatment has a content of hexavalent chromium of 0.050 μg/cm² or less as measured by a method compliant with EN15205 after exposure to an environment have a temperature of 80° C. and a relative humidity of 100% for 72 hours.

2. A composition for chemical conversion treatment comprising, based on the total composition,
1.0 g/L to 3.0 g/L of an aqueous cobalt-containing substance in cobalt equivalent,
at most 1.0 g/L of a pyrogallol compound in pyrogallol equivalent,
at least 1.5 g/L of an aqueous trivalent chromium-containing substance in chromium equivalent, and
an organophosphonate compound in an amount such that the ratio of the content of the organophosphonate compound to the content of the pyrogallol compound in pyrogallol equivalent is more than 10,
the composition being acidic and the ratio of the content of the pyrogallol compound in pyrogallol equivalent to the content of the aqueous cobalt-containing substance in cobalt equivalent being 0.1 to 10,
wherein a chemical conversion film formed on a metallic surface of a member by contacting the metallic surface with the composition for chemical conversion treatment has a content of hexavalent chromium of 0.030 μg/cm² or less as measured by a method compliant with EN15205 after exposure to an environment having a temperature of 80° C. and a relative humidity of 100% for 216 hours.

3. A composition for chemical conversion treatment comprising, based on the total composition,
at least 1.0 g/L and less than 1.0 g/L of an aqueous cobalt-containing substance in cobalt equivalent,
at most 1.0 g/L of a pyrogallol compound in pyrogallol equivalent,
at least 1.5 g/L of an aqueous trivalent chromium-containing substance in chromium equivalent, and
an organophosphonate compound in an amount such that the ratio of the content of the organophosphonate compound to the content of the aqueous cobalt-containing substance in cobalt equivalent is more than 10,
the composition being acidic and the ratio of the content of the pyrogallol compound in pyrogallol equivalent to the content of the aqueous cobalt-containing substance in cobalt equivalent being 0.1 to 10,
wherein a chemical conversion film formed on a metallic surface of a member by contacting the metallic surface with the composition for chemical conversion treatment has a content of hexavalent chromium of 0.030 μg/cm² or less as measured by a method compliant with EN15205 after exposure to an environment having a temperature of 80° C. and a relative humidity of 100% for 216 hours, and
the area of the chemical conversion film on which white rust is formed after a 192-hour salt spray test compliant with JIS H 8502 is less than 5% of the total area of the chemical conversion film.

4. A method of producing a member having a chemical conversion film on the surface of the member comprising contacting a metallic surface of the member with the composition for chemical conversion treatment according to claim 1.

5. A liquid composition for producing a composition for chemical conversion treatment to a metallic surface of a member comprising, based on the total composition,
0.5 g/L to 60 g/L of an aqueous cobalt-containing substance in cobalt equivalent,
0.25 g/L to 60 g/L of a pyrogallol compound in pyrogallol equivalent, and
at least 7.5 g/L of an aqueous trivalent chromium-containing substance in chromium equivalent,
wherein the ratio of the content of the pyrogallol compound in pyrogallol equivalent to the content of the aqueous cobalt-containing substance in cobalt equivalent is 0.015 to 10.

6. A liquid composition for producing a composition for chemical conversion treatment of a metallic surface of a member, comprising, based on the total composition,
5 g/L to 60 g/L of an aqueous cobalt-containing substance in cobalt equivalent,
at most 20 g/L of a pyrogallol compound in pyrogallol equivalent,
at least 7.5 g/L of an aqueous trivalent chromium-containing substance in chromium equivalent, and
an organophosphonate compound in an amount such that the ratio of the content of the organophosphonate compound to the content of the pyrogallol compound in pyrogallol equivalent is more than 10,
wherein the composition is acidic and the ratio of the content of the pyrogallol compound in pyrogallol equivalent to the content of the aqueous cobalt-containing substance in cobalt equivalent is 0.1 to 10.

7. A liquid composition for producing a composition for chemical conversion treatment of a metallic surface of a member comprising, based on the total composition,
at least 0.5 g/L and less than 20 g/L of an aqueous cobalt-containing substance in cobalt equivalent,
at most 20 g/L of a pyrogallol compound in pyrogallol equivalent,
at least 7.5 g/L of an aqueous trivalent chromium-containing substance in chromium equivalent, and
an organophosphonate compound in an amount such that the ratio of the content of the organophosphonate compound to the content of the aqueous cobalt-containing substance in cobalt equivalent is more than 10,
wherein the composition is acidic and the ratio of the content of the pyrogallol compound in pyrogallol equivalent to the content of the aqueous cobalt-containing substance in cobalt equivalent is 0.1 to 10.

8. A method of producing a member having a chemical conversion film on the surface of the member comprising contacting a metallic surface of the member with the composition for chemical conversion treatment according to claim 2.

9. A method of producing a member having a chemical conversion film on the surface of the member comprising contacting a metallic surface of the member with the composition for chemical conversion treatment according to claim 3.
